(19) United States
(12) Patent Application Publication
(10) Pub. No.: US 2011/0124210 A1
(43) Pub. Date: May 26, 2011

(54) PORTABLE ELECTRONIC DEVICE WITH A ROTARY SIGNAL TRANSMISSION INTERFACE

(76) Inventor: Kun-Hui Lai, Taipei Hsien (TW)

(21) Appl. No.: 12/719,000

(22) Filed: Mar. 7, 2010

(30) Foreign Application Priority Data
Nov. 23, 2009 (TW) 098221812

(51) Int. Cl. H01R 13/44

(52) U.S. Cl. 439/131

(57) ABSTRACT

A portable electronic device includes a housing having an opening formed on a lateral side of the housing and a containing space formed inside the housing, and a rotary module having a base connected to the housing in a rotatable manner. The base includes a first signal transmission interface disposed thereon for coupling to an external storage device, and the base rotates relative to the housing so as to hide the first signal transmission interface inside the containing space or to expose the first signal transmission interface out of the opening on the housing selectively.

### BACKGROUND OF THE INVENTION

1. Field of the Invention

The present invention relates to a portable electronic device, and more particularly, to a portable electronic device with a rotary signal transmission interface.

2. Description of the Prior Art

With the advanced technology of digital audio media, a user can apply newly revolutionary multimedia files. The digital audio media can be encoded as a digital file with smaller size, and the digital file can be stored in a portable non-volatile storage (NVS) device. Due to popularization of the digital audio media, a portable music player, such as a MP3 player, is utilized widespread. However, an additional transmission cable is necessary for electrically connecting the portable music player to a conventional electronic device for transmitting data between the portable music player and the conventional electronic device. The conventional connection design with the transmission cable is inconvenient and inaesthetic. Thus, design of a practical and aesthetic connecting mechanism for an external device is an important issue of the mechanical design of the portable electronic device.

### SUMMARY OF THE INVENTION

The present invention provides a portable electronic device with a rotary signal transmission interface for solving above drawbacks.

According to the claimed invention, a portable electronic device includes a housing having an opening formed on a lateral side of the housing and a containing space formed inside the housing, and a rotary module having a base connected to the housing in a rotatable manner. The base includes a first signal transmission interface disposed thereon for coupling to an external storage device, and the base rotates relative to the housing so as to hide the first signal transmission interface inside the containing space or to expose the first signal transmission interface out of the opening on the housing selectively.

According to the claimed invention, the containing space of the housing is a fan-shaped space, and the base is a fan-shaped structure accordingly.

According to the claimed invention, the base further includes a first area and a second area. The first signal transmission interface and the second signal transmission interface are respectively disposed on the first area and the second area, and the second signal transmission interface is exposed out of the opening on the housing when the base rotates relative to the housing for hiding the first signal transmission interface inside the containing space of the housing.

According to the claimed invention, the base is a semicircular structure, and the first area and the second area are quarter-circular structures, respectively.

According to the claimed invention, the rotary module further comprises an axle, and the base is pivoted to the rotary module via the axle.

According to the claimed invention, The portable electronic device further includes a recovering component connected to the rotary module for driving the rotary module to rotate from a position out of the opening on the housing into the containing space of the housing.

According to the claimed invention, the recovering component is a resilient component.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 3 are perspective drawings of a portable electronic device in different statuses according to a first embodiment of the present invention.

FIG. 4 is a functional block diagram of the portable electronic device according to the first embodiment of the present invention.

FIG. 5 and FIG. 6 are perspective drawings of a portable electronic device in different statuses according to a second embodiment of the present invention.

FIG. 7 to FIG. 10 are top views of the portable electronic device in different statuses according to the second embodiment of the present invention.

### DETAILED DESCRIPTION

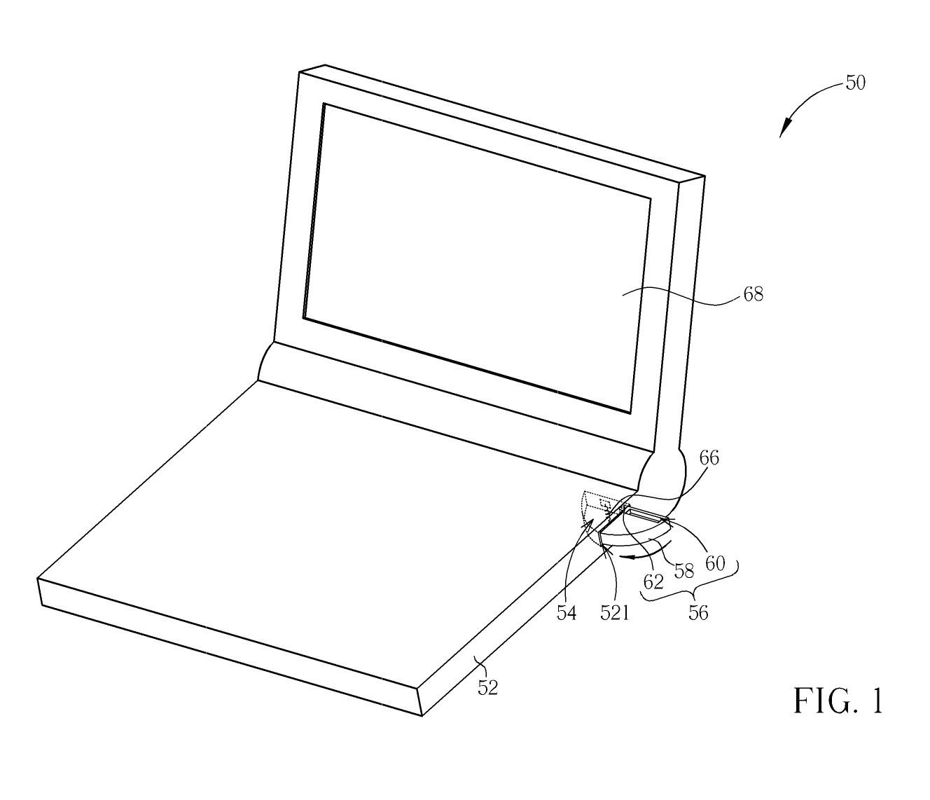

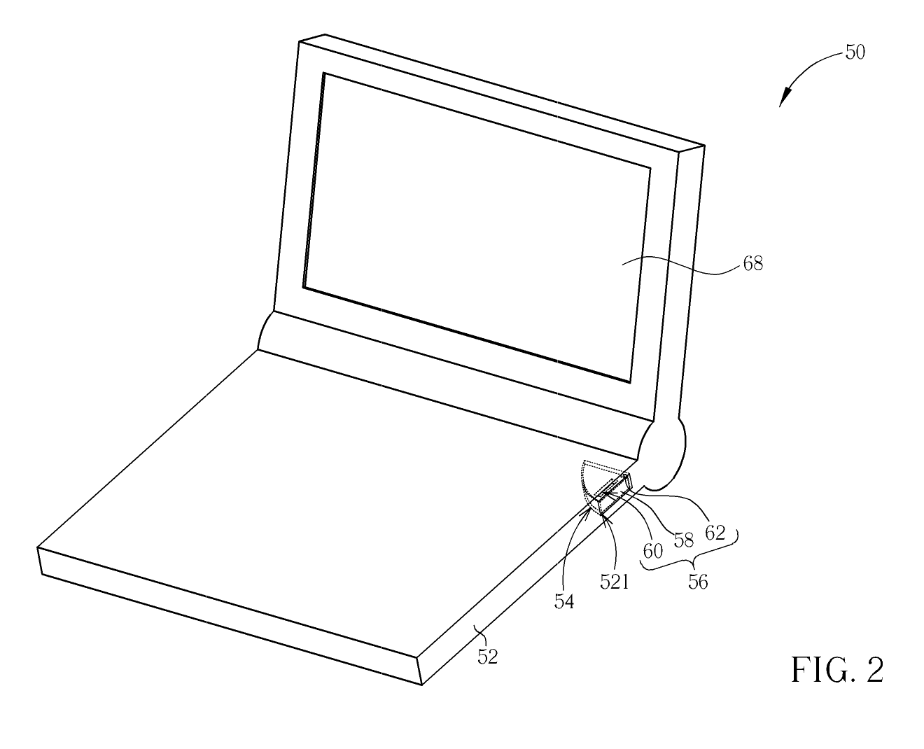

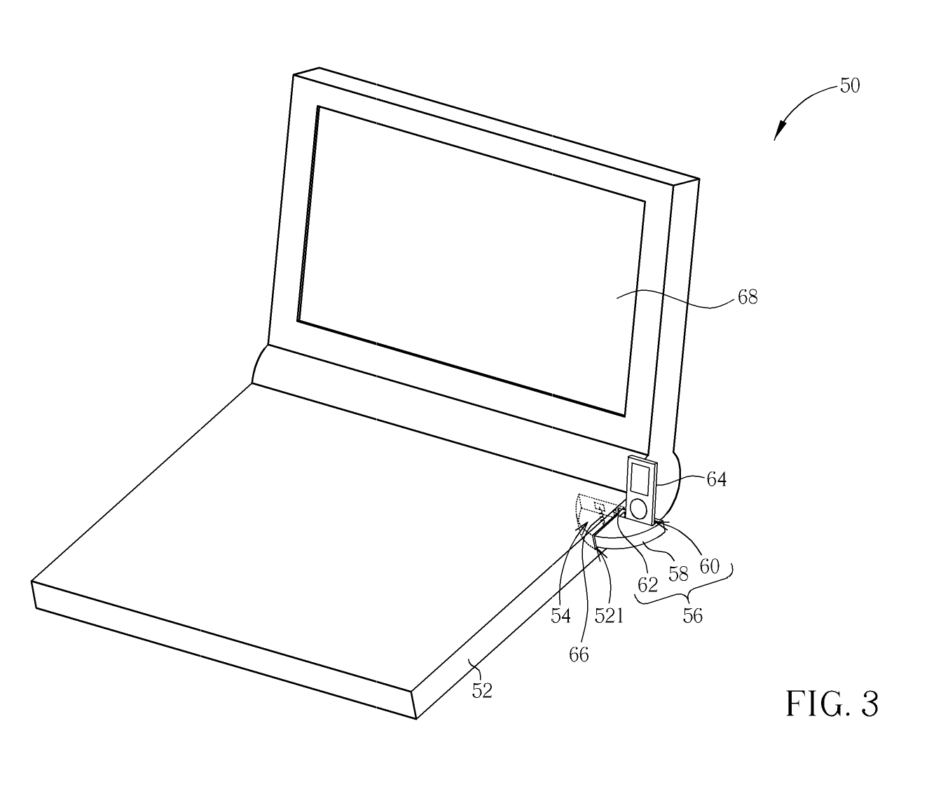

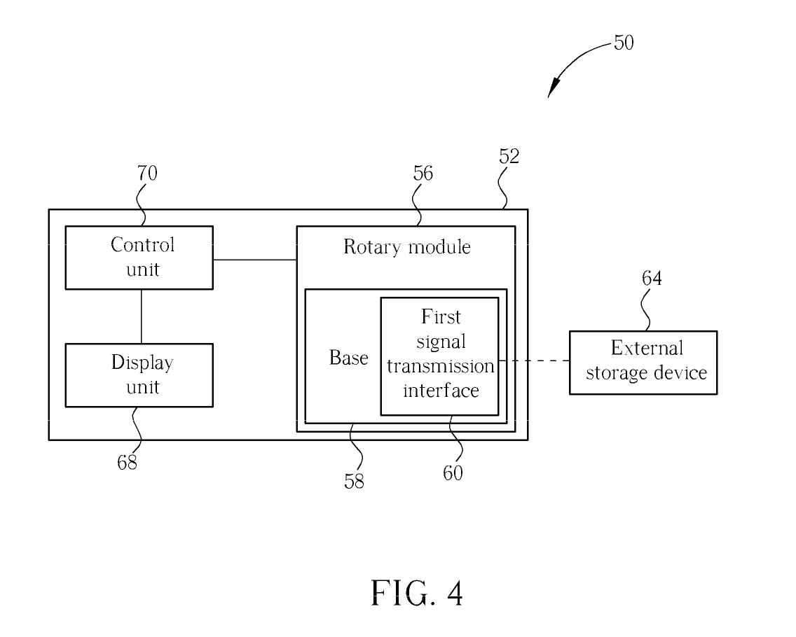

Please refer to FIG. 1 to FIG. 4. FIG. 1 to FIG. 3 are perspective drawings of a portable electronic device 50 in different statuses according to a first embodiment of the present invention. FIG. 4 is a functional block diagram of the portable electronic device 50 according to the first embodiment of the present invention. The portable electronic device 50 can be a notebook computer. The portable electronic device 50 includes a housing 52. The housing 52 can be a host housing. An opening 521 is formed on a lateral side of the housing 52, and a containing space 54 is formed inside the housing 52. The opening 521 on the housing 52 can be a slot disposed on a lateral side of the housing 52. The containing space 54 of the housing 52 can be a fan-shaped space. The portable electronic device 50 further includes a rotary module 56 hidden inside the containing space 54 of the housing 52 or exposed out of the opening 521 on the housing 52 in a rotatable manner. The rotary module 56 includes a base 58 connected to the housing 52 in a rotatable manner. The base 58 can be a fan-shaped structure corresponding to the fan-shaped space. A first signal transmission interface 60 is disposed on the base 58. The first signal transmission interface 60 can be a connector slot. The rotary module 56 further includes an axle 62, and the base 58 is pivoted to the axle 62, so that the base 58 can rotate relative to the housing 52 between a position exposing out of the opening 521 on the housing 52 as shown in FIG. 1 and a position hidden inside the containing space 54 of the housing 52 as shown in FIG. 2. Positions of the opening 521 and the containing space 54 of the present invention are not limited to the above-mentioned embodiment, which means the opening 521 and the containing space 54 of the housing 52 not only can be disposed on the lateral side of the housing but also can be disposed on an upper side of the housing 52, and so on. It depends on actual design.

When the rotary module 56 rotates relative to the housing 52 to the position exposing out of the opening 521 on the housing 52 as shown in FIG. 1, an external storage device 64 can be disposed inside the first signal transmission interface 60 of the base 58. The external storage device 64 can be a portable multimedia player, such as an iPod. The first signal transmission interface 60 is for coupling to the external storage device 64, so that signals or electricity can be transmitted between the external storage device 64 and the portable electronic device 50 via the first signal transmission interface 60. For example, the external storage device 64 can be electrified via the first signal transmission interface 60, or data can be transmitted between the external storage device 64 and the portable electronic device 50 via the first signal transmission interface 60. When the external storage device 64 is not connected to the first signal transmission interface 60, the rotary module 56 can be rotated from the position exposing out of the opening 521 on the housing 52 as shown in FIG. 1 into the position hidden inside the containing space 54 of the housing 52 as shown in FIG. 2 for providing protecting and dust-proofing functions for the first signal transmission interface 60. Mechanism of recovering the rotary module 56 can include pushing the rotary module 56 into the containing space 54 of the housing 52 manually. Or the portable electronic device 50 can further include a recovering component 66 connected to the rotary module 56 for driving the rotary module 56 to rotate from the position out of the opening 521 on the housing 52 into the containing space 54 of the housing 52. The recovering component 66 can be a resilient component, such as a spring. When the rotary module 56 is pulled relative to the housing 52 to the position exposing out of the opening 521 on the housing 52 as shown in FIG. 1, the recovering component 66 is stretched from an original length. When the rotary module 56 is released, the recovering component 66 can provide a resilient recovering force to the rotary module 56 for pulling the rotary module 56 back to the position containing inside the containing space 54 of the housing 52, so as to hide the rotary module 56 inside the housing 52. Operating mechanism of the recovering component 66 is not limited to the above-mentioned embodiment, and any mechanism capable of driving the rotary module 56 to rotate from the position exposing out of the opening 521 on the housing 52 to the position containing inside the containing space 54 of the housing 52 belongs to the scope of the present invention. Operating mechanism for driving the base 58 to rotate relative to the housing 52 can apply ordinary mechanical design or electrical design. For example, magnetic components can be respectively disposed on the base 58 and the housing 52, so that the base 58 can be switched between the position exposing out of the opening 521 on the housing 52 and the position hidden inside the containing space 54 of the housing 52 by magnetic attraction or magnetic repulsion. In addition, two electromagnets can be respectively disposed on the base 58 and the housing 52, so that magnetism of the electromagnets can be controlled by signals generated by a switch for switching the magnetic attraction or the magnetic repulsion of the electromagnets. Furthermore, a mechanical driving device, such as a motor, can be used for driving the base 58 to rotate relative to the housing 52. Any operational mechanism capable of driving the base 58 to rotate relative to the housing 52 belongs to the scope of the present invention.

As shown in FIG. 4, the portable electronic device 50 further includes a display unit 68. The display unit 68 can be a liquid crystal display. The portable electronic device 50 further includes a control unit 70 installed inside the housing 52 for receiving signals of the external storage device 64 transmitted from the first signal transmission interface 60 and for controlling the display unit 68 to display corresponding images. That is to say, when the rotary module 56 rotates relative to the housing 52 to the position exposing out of the opening 521 on the housing 52 as shown in FIG. 1 and the external storage device 64 is connected to the first signal transmission interface 60 of the base 58, the data can be transmitted between the external storage device 64 and the portable electronic device 50 via the first signal transmission interface 60. Meanwhile, a user can read connection status of the display unit 68 and the external storage device 64 at the same view angle. In addition, because the data can be transmitted between the external storage device 64 and the portable electronic device 50 via the first signal transmission interface 60, there is no need to apply an additional transmission cable, such as a power cable or a signal transmission cable, to connect between the external storage device 64 and the portable electronic device 50, so as to economize cable cost and to improve operating convenience.

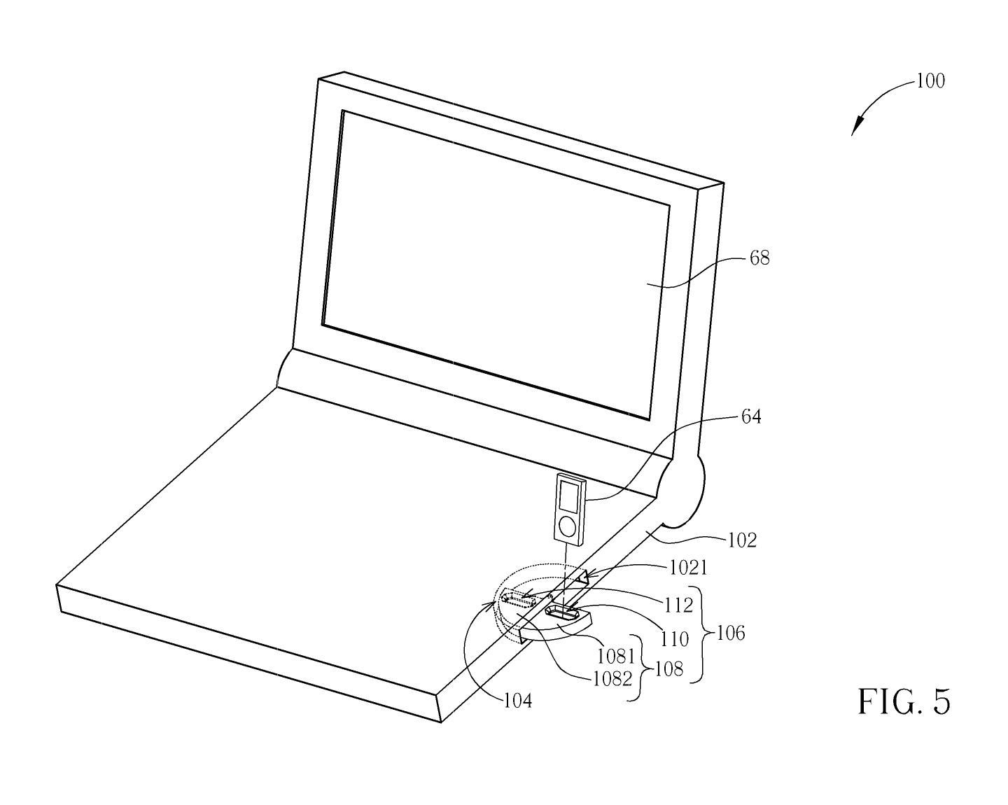

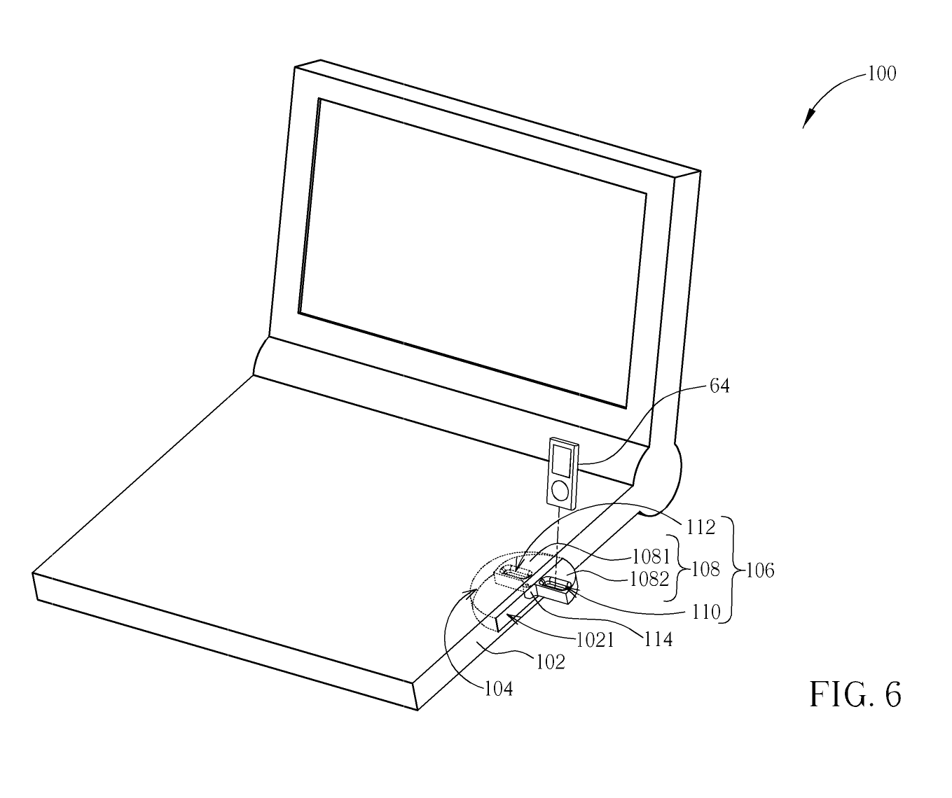

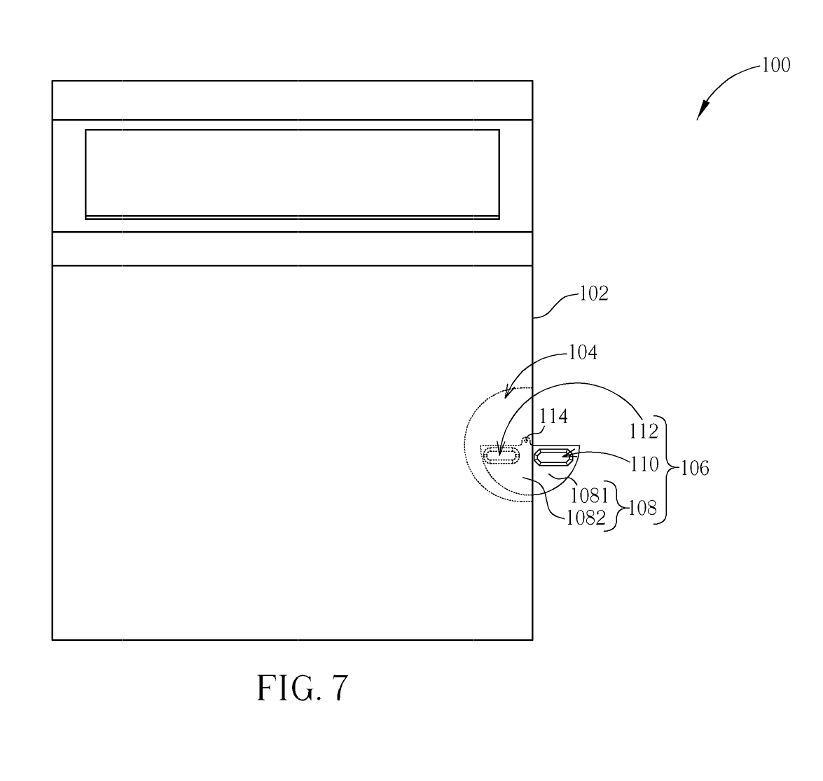

In addition, please refer to FIG. 5 to FIG. 10. FIG. 5 and FIG. 6 are perspective drawings of a portable electronic device 100 in different statuses according to a second embodiment of the present invention. FIG. 7 to FIG. 10 are top views of the portable electronic device 100 in different statuses according to the second embodiment of the present invention. In this embodiment, components having the same numerals as ones of the above-mentioned embodiment have the same structures and functions, and detailed description is omitted herein for simplicity. The portable electronic device 100 can be a notebook computer. The portable electronic device 100 includes a housing 102. The housing 102 can be a host housing. An opening 1021 is formed on a lateral side of the housing 102, and a containing space 104 is formed inside the housing 102. The opening 1021 on the housing 102 can be a slot, and the containing space 104 of the housing 102 can be a semicircular containing space. The portable electronic device 100 further includes a rotary module 106 having a base 108 connected to the housing 102 in a rotatable manner for rotating between a position exposing out of the opening 1021 on the housing 102 and a position hidden inside the containing space 104 of the housing 102. The base 108 can be a semicircular structure. The base 108 includes a first area 1081 and a second area 1082. The first area 1081 and the second area 1082 can be quarter-circular structures, respectively. The base 108 includes a first signal transmission interface 110 and a second signal transmission interface 112. The first signal transmission interface 110 and the second signal transmission interface 112 can be connector slots respectively, such as a USB slot. The first signal transmission interface 110 and the second signal transmission interface 112 can be disposed on the first area 1081 and the second area 1082 respectively. The first signal transmission interface 110 and the second signal transmission interface 112 can be used for coupling to different external storage modules 64. For example, the first signal transmission interface 110 and the second signal transmission interface 112 can be connectors conforming to different interfaces. The first signal transmission interface 110 and the second signal transmission interface 112 can further be the connector slots with the same interface so as to couple to the same external storage module 64. The rotary module 106 further includes an axle 114, and the base 108 is pivoted to the axle 114, so that the base 108 can rotate relative to the housing 102.

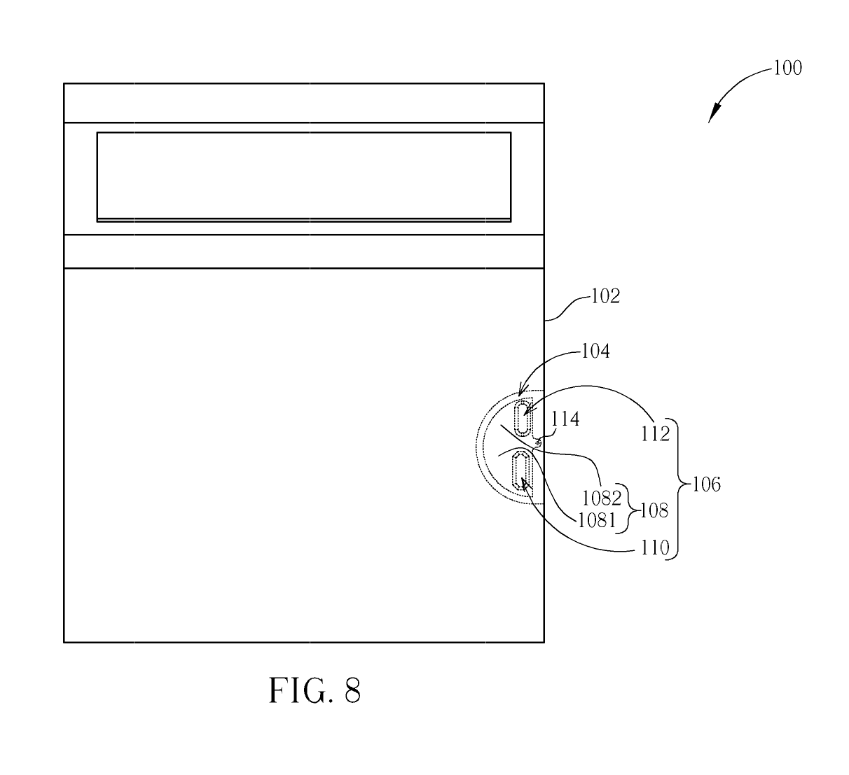

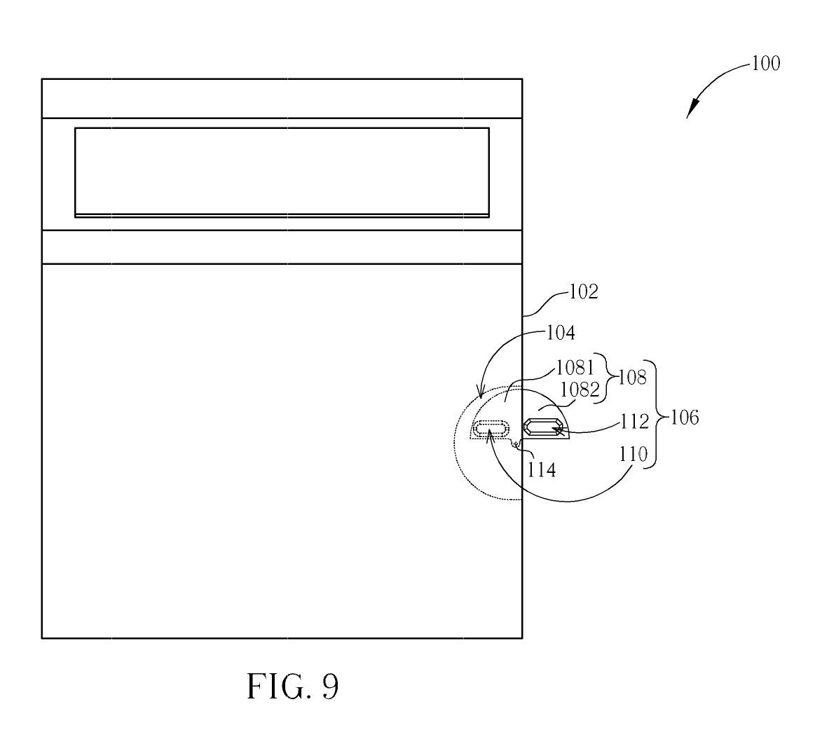

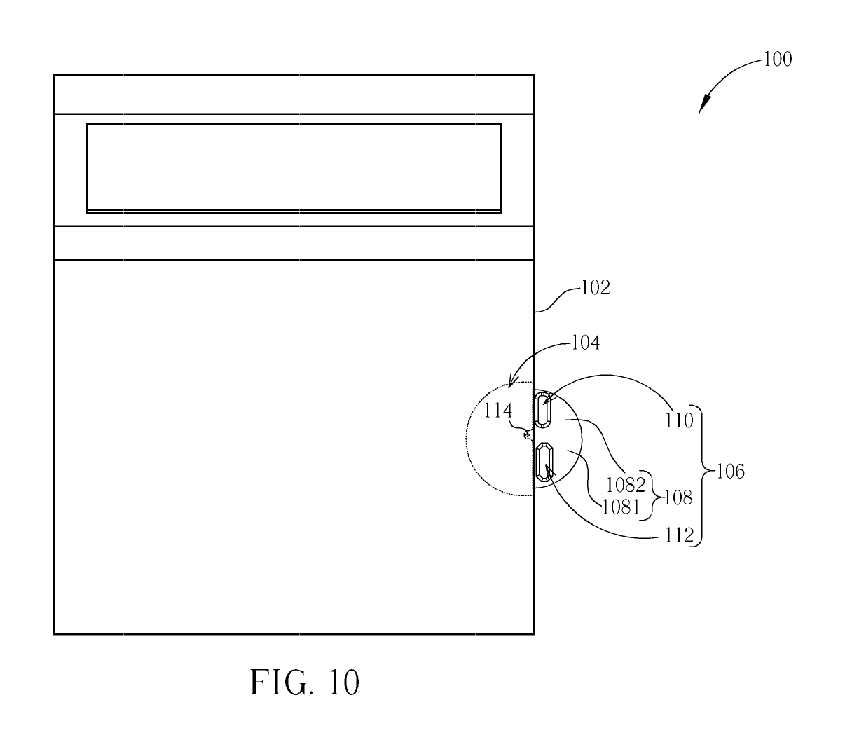

In this embodiment, because the base 108 of the rotary module 106 is a semicircular structure whereon two signal transmission interfaces are disposed, operating modes of the rotary module 106 can be expanded. As shown in FIG. 7 to FIG. 10, the rotary module 106 can rotate relative to the housing 102 to a position where the first area 1081 is exposed out of the housing 102 and the second area 1082 is contained inside the containing space 104 of the housing 102 shown in FIG. 7. Meanwhile, the first signal transmission interface 110 can be used for coupling to the external storage module 64. The rotary module 106 can further rotate relative to the housing 102 to a position where the first area 1081 and the second area 1082 are contained inside the containing space 104 of the housing 102 as shown in FIG. 8. Meanwhile, the first signal transmission interface 110 and the second signal transmission interface 112 are contained inside the housing 102 for providing protecting and dust-proofing functions for the first signal transmission interface 110 and the second signal transmission interface 112. The rotary module 106 can further rotate relative to the housing 102 to a position where the second area 1082 is exposed out of the housing 102 and the first area 1081 is contained inside the containing space 104 of the housing 102 as shown in FIG. 9. Meanwhile, the second signal transmission interface 112 can be used for coupling to the external storage module 64. The rotary module 106 can further rotate relative to the housing 102 to a position where the first area 1081 and the second area 1082 are both exposed out of the housing 102 as shown in FIG. 10. Meanwhile, the first signal transmission interface 110 and the second signal transmission interface 112 can be used for coupling to the external storage module 64, simultaneously. As mentioned above, the second embodiment performs four different operating modes. The base of the rotary module of the present invention can further be a circular structure whereon four signal transmission interfaces are disposed, so that the four signal transmission interfaces can be selectively exposed out of the housing or contained inside the containing space of the housing in a rotatable manner. Working principle of this embodiment is the same as the above-mentioned embodiment, and detailed description is omitted herein for simplicity. That is to say, any mechanical design for selectively rotating the signal transmission interface to be exposed out of the housing and to be contained inside the containing space of the housing belongs to the scope of the present invention.

Comparing to the prior art, the present invention selectively switches the position of the signal transmission interface to be exposed out of the housing or to be hidden inside the containing space of the housing in a rotatable manner, so that when the signal transmission interface is not connected to the external storage module, the signal transmission interface can be contained inside the containing space of the housing in the rotatable manner for providing protecting and dust-proofing functions for the signal transmission interface. When the signal transmission interface is used to be coupled to the external storage module, the signal transmission interface can rotate to be exposed out of the housing so as to couple the signal transmission interface to the external storage module and to transmit the data between the external storage module and the portable electronic device via the signal transmission interface. Thus, the user can read the connection status of the display unit and the external storage module at the same view angle for improving operating convenience. Mechanical design of the rotary module of the present invention not only can simplify the structure, but also can have preferred aesthetic when the rotary module is contained inside the housing. Besides, due to transmission between the external storage module and the portable electronic device via the signal transmission interface, there is no need to apply an additional transmission cable between the external storage module and the portable electronic device, so that the present invention can economize the cable cost and improve the operating convenience.

Those skilled in the art will readily observe that numerous modifications and alterations of the device and method may be made while retaining the teachings of the invention.

What is claimed is:

1. A portable electronic device comprising:
a housing having an opening formed on a lateral side of the housing and a containing space formed inside the housing; and
a rotary module having a base connected to the housing in a rotatable manner, wherein the base comprises a first signal transmission interface disposed thereon for coupling to an external storage device, and the base rotates relative to the housing so as to hide the first signal transmission interface inside the containing space or to expose the first signal transmission interface out of the opening on the housing selectively.

2. The portable electronic device of claim 1, wherein the containing space of the housing is a fan-shaped space, and the base is a fan-shaped structure accordingly.

3. The portable electronic device of claim 1, wherein the base further comprises a first area and a second area, the first signal transmission interface and the second signal transmission interface are respectively disposed on the first area and the second area, and the second signal transmission interface is exposed out of the opening on the housing when the base rotates relative to the housing for hiding the first signal transmission interface inside the containing space of the housing.

4. The portable electronic device of claim 3, wherein the base is a semicircular structure, and the first area and the second area are quarter-circular structures respectively.

5. The portable electronic device of claim 1, wherein the rotary module further comprises an axle, and the base is pivoted to the rotary module via the axle.

6. The portable electronic device of claim 1 further comprising:
a recovering component connected to the rotary module for driving the rotary module to rotate from a position out of the opening on the housing into the containing space of the housing.

7. The portable electronic device of claim 6, wherein the recovering component is a resilient component.
